(19) United States
(12) Patent Application Publication
(10) Pub. No.: US 2017/0244329 A1
(43) Pub. Date: Aug. 24, 2017

(54) CONVERTER CIRCUIT AND OPERATING METHOD THEREOF

(71) Applicant: Macau University of Science and Technology, Taipa (CN)

(72) Inventor: Xiaodong Li, Taipa (CN)

(21) Appl. No.: 15/048,157

(22) Filed: Feb. 19, 2016

(51) Int. Cl. H02M 3/335

(52) U.S. Cl. CPC H02M 3/33546

(57) ABSTRACT

A converter circuit regulating power transfer from a power source to a load includes a first switching circuit arranged to be connected across an output of the power source, and including a plurality of switches. A second switching circuit including a plurality of switches is arranged to be connected across an input of the load. An inductive component electrically connects the first switching circuit with the second switching circuit. A controller is operably connected with the plurality of switches in both the first and second switching circuits, and receives a control signal for controlling switching of the plurality of switches in both the first and second switching circuit; generates gating signals to be provided to the plurality of switches in both the first and second switching circuit based on the control signal; and provide the gating signals to the plurality of switches in both the first and second switching circuit.

### TECHNICAL FIELD

The present invention relates to a converter circuit and a method for operating a converter circuit. More particularly, although not exclusively, the present invention relates to a phase-shifted resonant DC/DC converter circuit arranged to regulate power transfer from a DC voltage source to a load and its method of operation.

### BACKGROUND

DC/DC converter circuits can be used in switched-mode power supply, battery charger and renewable energy generation for regulating bidirectional power transfer between power sources or unidirectional power supply from a power source to a load. Typically, a DC/DC converter is operable to convert an input voltage from one level to another so as to be outputted to a power source or a load. Many existing DC/DC converter circuits include complex power regulation circuitries, which substantially complicate manufacturing process and increase manufacturing cost.

### SUMMARY OF THE INVENTION

In accordance with a first aspect of the present invention, there is provided a converter circuit arranged to regulate power transfer from a power source to a load, comprising: a first switching circuit arranged to be connected across an output of the power source, the first switching circuit comprises a plurality of switches; a second switching circuit arranged to be connected across an input of the load, the second switching circuit comprises a plurality of switches; an inductive component electrically connecting the first switching circuit with the second switching circuit; and a controller operably connected with the plurality of switches in the first switching circuit and the plurality of switches in the second switching circuit, the controller being arranged to:

receive a control signal for controlling switching of the plurality of switches in the first switching circuit and the plurality of switches in the second switching circuit; generate gating signals to be provided to the plurality of switches in the first switching circuit and the plurality of switches in the second switching circuit based on the control signal; and provide the gating signals to the plurality of switches in the first switching circuit and the plurality of switches in the second switching circuit so as to regulate power transfer from the power source to the load. Preferably, the power source is a voltage source such as a DC voltage source. Preferably, the converter circuit is a DC/DC converter circuit.

In one embodiment of the first aspect, the plurality of switches of the first switching circuit comprises a first pair of switches connected in series such that the first pair of switches is arranged to be connected across the output of the power source.

In one embodiment of the first aspect, the first switching circuit further comprises a pair of capacitors connected in series, and the pair of capacitors is connected in parallel with the first pair of switches such that the pair of capacitors is arranged to be connected across the output of the power source.

In one embodiment of the first aspect, the plurality of switches of the second switching circuit comprises a third pair of switches connected in parallel, such that each of the third pair of switches is arranged to be connected across the input of the load.

In one embodiment of the first aspect, each of the third pair of switches is connected with a respective diode in series to form a switch-diode pair, thereby forming two switch-diode pairs arranged to be connected in parallel across the input of the load.

In one embodiment of the first aspect, the inductive component is a transformer with a primary winding connected with the first switching circuit and a secondary winding connected with the second switching circuit. The turn ratio of the transformer can be selected based on applications, as well as power requirements of the power source and/or the load.

In one embodiment of the first aspect, the converter circuit further comprises: a resonance circuit connected between the first switching circuit and the inductive component (e.g., the transformer).

In one embodiment of the first aspect, the resonance circuit comprises: an inductor and capacitor pair connected in series between the first switching circuit and the inductive component.

In one embodiment of the first aspect, a resonance frequency of the inductor and capacitor pair is substantially identical to a switching frequency (i.e., reciprocal of the switching period) of one or more the plurality of switches in the first switching circuit and the plurality of switches in the second switching circuit. In one example, the plurality of switches in the first switching circuit and the plurality of switches in the second switching circuit are controlled to have identical switching period/frequency.

In one embodiment of the first aspect, the resonance circuit further comprises: a further inductor or a further capacitor connected in parallel across an output of the first switching circuit. Preferably, the further inductor or further capacitor is connected downstream of the inductor and capacitor pair, i.e., closer to the inductive component.

In one embodiment of the first aspect, the controller is arranged to control the first pair of switches and the third pair of switches to have substantially identical switching period. Although the switches have the same switching period, they may or may not be switched-on or switched-off at the same time.

In one embodiment of the first aspect, the controller is further arranged to perform one or more (e.g., all) of the following: switch on and off the first pair of switches complementarily (i.e., switch-on one of the first pair of switches and switch-off another one of the first pair of switches at substantially the same time) such that each of the first pair of switches has a duty cycle of about 50% with a dead time therebetween; switch on and off the third pair of switches complementarily (i.e., switch-on one of the third pair of switches and switch-off another one of the third pair of switches at substantially the same time) such that each of the third pair of switches has a duty cycle of about 50% with a dead time therebetween; and control a duration from a switch-on time of one of the first pair of switches to switch-on time of one of the third pair of switches based on the control signal, wherein the duration is controlled to be between 0 and half the switching period. The expression “about” 50% is used to take into account the dead time between the switching-off of a switch and a switching-on of another switch. The duration essentially controls the amount of power flowing from the power source to the load. Preferably, the duration is the only variable parameter in the circuit.

In one embodiment of the first aspect, the plurality of switches of the first switching circuit further comprises a second pair of switches connected in series, the second pair of switches is connected in parallel with the first pair of switches; and the controller is further arranged to control the first pair of switches, the second pair of switches and the third pair of switches to have substantially identical switching period. Although the switches have the same switching period, they may or may not be switched-on or switched-off at the same time.

In one embodiment of the first aspect, the controller is further arranged to: switch on and off the second pair of switches complementarily (i.e., switch-on one of the second pair of switches and switch-off another one of the second pair of switches at substantially the same time) such that each of the second pair of switches has a duty cycle of about 50% with a dead time therebetween; switch on and off one of the second pair of switches and one of the first pair of switches synchronously (i.e., switch-on one of the second pair of switches and switch-on one of the first pair of switches at substantially the same time); and switch on and off another one of the second pair of switches and another one of the first pair of switches synchronously (i.e., switch-on another one of the second pair of switches and switch-on another one of the first pair of switches at substantially the same time). The expression “about” 50% is used to take into account the dead time between the switching-off of a switch and a switching-on of another switch.

In one embodiment of the first aspect, the converter circuit further comprises an input capacitor arranged to be connected across the power source, between the power source and the first switching circuit; and an output capacitor arranged to be connected across the second switching circuit, between the second switching circuit and the load.

In one embodiment of the first aspect, the plurality of switches in the first switching circuit and the plurality of switches in the second switching circuit are active switches such as power semiconductor switches, transistors, or other switching components that can be controlled by one or more controllers. Examples of these transistors include bipolar junction transistors (BJT), junction gate field-effect transistors (JFET), metal-oxide-semiconductor field-effect transistors (MOSFET), and hetero-structure field-effect transistors (HFET)/high-electron-mobility transistors (HEMT) that can be of any type (e.g., PNP, NPN) or channel (e.g., p-channel, n-channel), and can operate at different operation modes (e.g., depletion mode, enhancement mode). In a preferred embodiment, the switches are controllable power semiconductor switches such as MOSFETs. Preferably, each MOSFETS has a body/bypass diode connected, e.g., in an anti-parallel manner.

In accordance with a second aspect of the present invention, there is provided a method for operating a converter circuit arranged to regulate power transfer from a power source to a load, comprising the steps of: receiving a control signal for controlling switching of a plurality of switches in a first switching circuit and a plurality of switches in a second switching circuit of the converter circuit, wherein the first switching circuit is arranged to be connected across an output of the power source, the second switching circuit is arranged to be connected across an input of the load, and the first and second switching circuits are electrically connected through an inductive component; generating gating signals to be provided to the plurality of switches in the first switching circuit and the plurality of switches in the second switching circuit based on the control signal; and providing the gating signals to the plurality of switches in the first switching circuit and the plurality of switches in the second switching circuit so as to regulate power transfer from the power source to the load. Preferably, the power source is a voltage source such as a DC voltage source. Preferably, the converter circuit is a DC/DC converter circuit.

In one embodiment of the second aspect, the plurality of switches of the first switching circuit comprises a first pair of switches connected in series such that the first pair of switches is arranged to be connected across the output of the power source; and the plurality of switches of the second switching circuit comprises a third pair of switches connected in parallel such that each of the third pair of switches is arranged to be connected across the input of the load; and the method further comprises the step of: controlling the first pair of switches and the third pair of switches to have substantially identical switching period. Although the switches have the same switching period, they may or may not be switched-on or switched-off at the same time.

In one embodiment of the second aspect, the method further comprising one or more (e.g. all) of the steps of: switching on and off the first pair of switches complementarily (i.e., switch-on one of the first pair of switches and switch-off another one of the first pair of switches at substantially the same time) such that each of the first pair of switches has a duty cycle of about 50% with a dead time therebetween; switching on and off the third pair of switches complementarily (i.e., switch-on one of the third pair of switches and switch-off another one of the third pair of switches at substantially the same time) such that each of the third pair of switches has a duty cycle of about 50% with a dead time therebetween; and controlling a duration from a switch-on time of one of the first pair of switches to switch-on time of one of the third pair of switches based on the control signal, wherein the duration is controlled to be between 0 and half the switching period. The expression “about” 50% is used to take into account the dead time between the switching-off of a switch and a switching-on of another switch. The duration essentially controls the amount of power flowing from the power source to the load. Preferably, the duration is the only variable parameter in the circuit.

In one embodiment of the second aspect, the plurality of switches of the first switching circuit further comprises a second pair of switches connected in series, the second pair of switches is connected in parallel with the first pair of switches; and the method further comprises the step of: controlling the first pair of switches, the second pair of switches and the third pair of switches to have substantially identical switching period. Although the switches have the same switching period, they may or may not be switched-on or switched-off at the same time.

In one embodiment of the second aspect, the method further comprising one or more (e.g. all) of the steps of: switching on and off the second pair of switches complementarily (i.e., switch-on one of the second pair of switches and switch-off another one of the second pair of switches at substantially the same time) such that each of the second pair of switches has a duty cycle of about 50% with a dead time therebetween; switching on and off one of the second pair of switches and one of the first pair of switches synchronously (i.e., switch-on one of the second pair of switches and switch-on one of the first pair of switches at substantially the same time); and switching on and off another one of the second pair of switches and another one of the first pair of switches synchronously (i.e., switch-on another one of the second pair of switches and switch-on another one of the first pair of switches at substantially the same time). The expression “about” 50% is used to take into account the dead time between the switching-off of a switch and a switching-on of another switch.

In accordance with a third aspect of the present invention, there is provided a controller for a converter circuit arranged to regulate power transfer from a power source to a load, wherein the controller is arranged to: receive a control signal for controlling switching of a plurality of switches in a first switching circuit and a plurality of switches in a second switching circuit of the converter circuit, wherein the first switching circuit is arranged to be connected across an output of the power source, the second switching circuit is arranged to be connected across an input of the load, and the first and second switching circuits are electrically connected through an inductive component; generate gating signals to be provided to the plurality of switches in the first switching circuit and the plurality of switches in the second switching circuit based on the control signal; and provide the gating signals to the plurality of switches in the first switching circuit and the plurality of switches in the second switching circuit so as to regulate power transfer from the power source to the load. Preferably, the power source is a voltage source such as a DC voltage source. Preferably, the converter circuit is a DC/DC converter circuit.

In one embodiment of the third aspect, the plurality of switches of the first switching circuit comprises a first pair of switches connected in series such that the first pair of switches are arranged to be connected across the output of the power source; and the plurality of switches of the second switching circuit comprises a third pair of switches connected in parallel such that each of the third pair of switches is arranged to be connected across the input of the load; and the controller is further arranged to: control the first pair of switches and the third pair of switches to have substantially identical switching period. Although the switches have the same switching period, they may or may not be switched-on or switched-off at the same time.

In one embodiment of the third aspect, the controller is further arranged to perform one or more (e.g., all) of the following: switch on and off the first pair of switches complementarily (i.e., switch-on one of the first pair of switches and switch-off another one of the first pair of switches at substantially the same time) such that each of the first pair of switches has a duty cycle of about 50% with a dead time therebetween; switch on and off the third pair of switches complementarily (i.e., switch-on one of the third pair of switches and switch-off another one of the third pair of switches at substantially the same time) such that each of the third pair of switches has a duty cycle of about 50% with a dead time therebetween; and control a duration from a switch-on time of one of the first pair of switches to switch-on time of one of the third pair of switches based on the control signal, wherein the duration is controlled to be between 0 and half the switching period. The expression “about” 50% is used to take into account the dead time between the switching-off of a switch and a switching-on of another switch. The duration essentially controls the amount of power flowing from the power source to the load. Preferably, the duration is the only variable parameter in the circuit.

In one embodiment of the third aspect, the plurality of switches of the first switching circuit further comprises a second pair of switches connected in series, the second pair of switches is connected in parallel with the first pair of switches; and the controller is further arranged to: control the first pair of switches, the second pair of switches and the third pair of switches to have substantially identical switching period. Although the switches have the same switching period, they may or may not be switched-on or switched-off at the same time.

In one embodiment of the third aspect, the controller is further arranged to perform one or more (e.g., all) of the following: switch on and off the second pair of switches complementarily (i.e., switch-on one of the second pair of switches and switch-off another one of the second pair of switches at substantially the same time) such that each of the second pair of switches has a duty cycle of about 50% with a dead time therebetween; switch on and off one of the second pair of switches and one of the first pair of switches synchronously (i.e., switch-on one of the second pair of switches and switch-on one of the first pair of switches at substantially the same time); and switch on and off another one of the second pair of switches and another one of the first pair of switches synchronously (i.e., switch-on another one of the second pair of switches and switch-on another one of the first pair of switches at substantially the same time). The expression “about” 50% is used to take into account the dead time between the switching off of a switch and a switching on of another switch.

In one embodiment of the third aspect, the plurality of switches in the first switching circuit and the plurality of switches in the second switching circuit are active switches such as power semiconductor switches, transistors, or other switching components that can be controlled by one or more controllers. Examples of these transistors include bipolar junction transistors (BJT), junction gate field-effect transistors (JFET), metal-oxide-semiconductor field-effect transistors (MOSFET), and hetero-structure field-effect transistors (HFET)/high-electron-mobility transistors (HEMT) that can be of any type (e.g., PNP, NPN) or channel (e.g., p-channel, n-channel), and can operate at different operation modes (e.g., depletion mode, enhancement mode). In a preferred embodiment, the switches are controllable power semiconductor switches such as MOSFETs. Preferably, each MOSFETS has a body/bypass diode connected, e.g., in an anti-parallel manner.

In accordance with a fourth aspect of the present invention, there is provided a non-transient computer readable medium for storing computer instructions that, when executed by at least one controller or processor, causes at least one controller or processor to perform a method for operating a converter circuit arranged to regulate power transfer from a power source to a load, comprising the steps of: receiving a control signal for controlling switching of a plurality of switches in a first switching circuit and a plurality of switches in a second switching circuit of the converter circuit, wherein the first switching circuit is arranged to be connected across an output of the power source, the second switching circuit is arranged to be connected across an input of the load, and the first and second switching circuits are electrically connected through an inductive component; generating gating signals to be provided to the plurality of switches in the first switching circuit and the plurality of switches in the second switching circuit based on the control signal; and providing the gating signals to the plurality of switches in the first switching circuit and the plurality of switches in the second switching circuit so as to regulate power transfer from the power source to the load.

### BRIEF DESCRIPTION OF THE DRAWINGS

Embodiments of the present invention will now be described, by way of example, with reference to the accompanying drawings in which:

FIG. 1 is a simplified circuit diagram of a converter circuit in accordance with one embodiment of the present invention;

FIG. 2A is a circuit diagram of the first switching circuit in the converter circuit of FIG. 1 in accordance with one embodiment of the present invention;

FIG. 2B is a circuit diagram of the first switching circuit in the converter circuit of FIG. 1 in accordance with another embodiment of the present invention;

FIG. 2C is a circuit diagram of the first switching circuit in the converter circuit of FIG. 1 in accordance with yet another embodiment of the present invention;

FIG. 3A is a circuit diagram of a resonance circuit in the converter circuit of FIG. 1 in accordance with one embodiment of the present invention;

FIG. 3B is a circuit diagram of a resonance circuit in the converter circuit of FIG. 1 in accordance with another embodiment of the present invention;

FIG. 3C is a circuit diagram of a resonance circuit in the converter circuit of FIG. 1 in accordance with yet another embodiment of the present invention; and

FIG. 4 is a graph showing waveforms of the operation of the switches in the converter circuit of FIG. 1, as well as the respective voltage and current waveforms obtained in the converter circuit of FIG. 1 using the first switching circuit of FIGS. 2A to 2C.

### DETAILED DESCRIPTION OF THE PREFERRED EMBODIMENT

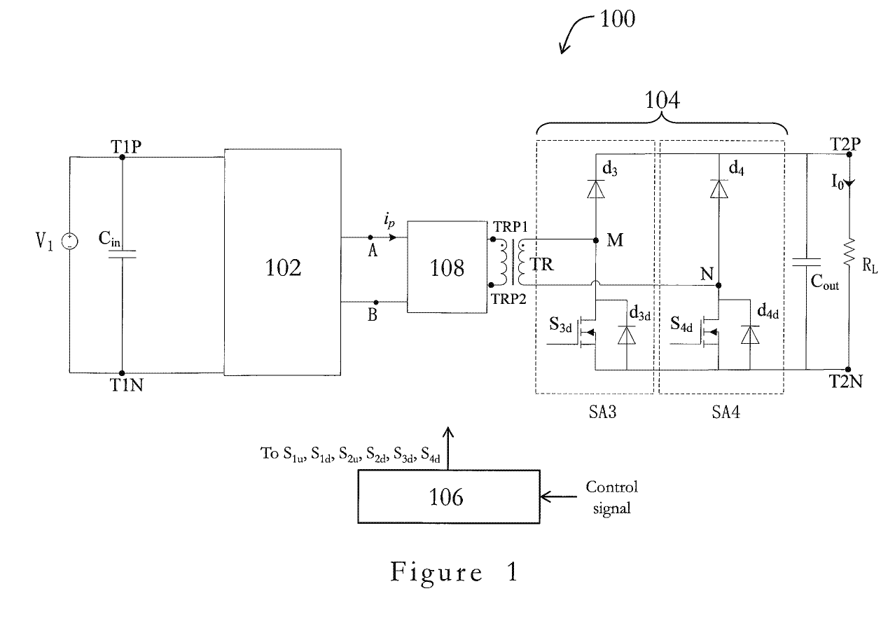

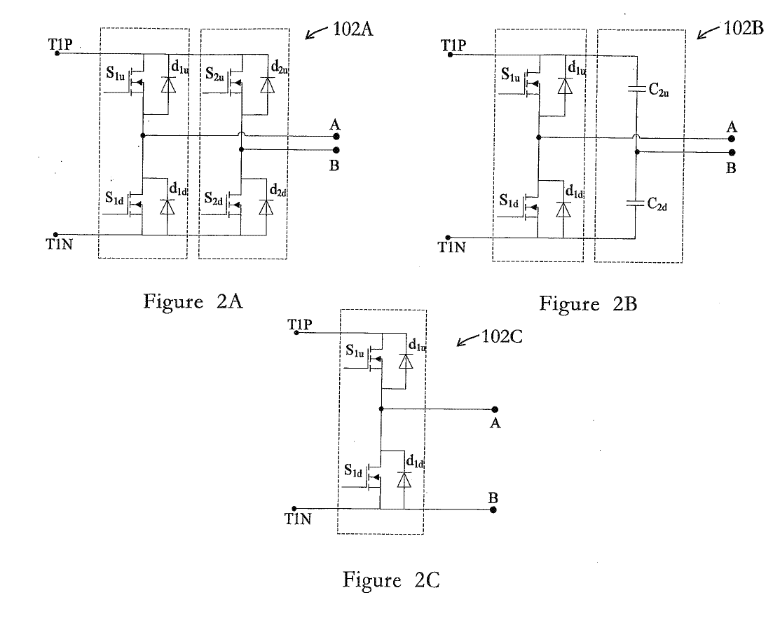

Referring to FIGS. 1-2C, there is provided a converter circuit 100 arranged to regulate power transfer from a power source to a load, comprising: a first switching circuit 102 arranged to be connected across an output of the power source V₁, the first switching circuit 102 comprises a plurality of switches; a second switching circuit 104 arranged to be connected across an input of the load R_{L}, the second switching circuit 104 comprises a plurality of switches; an inductive component TR connected between the first switching circuit 102 and the second switching circuit 104; and a controller 106 operably connected with the plurality of switches in the first switching circuit 102 and the plurality of switches in the second switching circuit 104, the controller 106 being arranged to: receive a control signal for controlling switching of the plurality of switches in the first switching circuit 102 and the plurality of switches in the second switching circuit 104; generate gating signals to be provided to the plurality of switches in the first switching circuit 102 and the plurality of switches in the second switching circuit 104 based on the control signal; and provide the gating signals to the plurality of switches in the first switching circuit 102 and the plurality of switches in the second switching circuit 104 so as to regulate power transfer from the power source V₁ to the load R_{L}. Preferably, the converter circuit 100 also includes a resonance circuit 108 connected between the first switching circuit 102 and the inductive component TR.

FIG. 1 shows a simplified circuit diagram of a converter circuit 100 in accordance with one embodiment of the present invention. In the present invention, the power source V₁ is preferably a voltage source and in particular a DC voltage source. The converter circuit 100 is preferably a DC/DC converter circuit arranged to regulate power transfer from a DC power source V₁ to a load R_{L}. In some other embodiments, however, the power source may be other AC or DC current/voltage sources, and the converter circuit 100 may be operable to regulate power transfer from these power sources to the load, or to regulate power transfer between two of these power sources.

As shown in FIG. 1, the converter circuit 100 includes a first switching circuit 102 arranged to be connected across an output of the voltage source V₁. The first switching circuit 102 is preferably connected across the voltage source V₁ at nodes T1P and T1N. Optionally, an input capacitor Cᵢₙ that acts as a high frequency filter is also connected across the voltage source V₁ at nodes T1P and T1N, between the voltage source V₁ and the first switching circuit 102. Different embodiments of the first switching circuit 102 in the converter circuit 100 of present invention are shown in FIGS. 2A to 2C, and are described below.

FIG. 2A shows a first switching circuit 102A in accordance with one embodiment of the present invention. The first switching circuit 102A in FIG. 2A is a bridge circuit with a first pair of switches S₁ᵤ,S_{1d} connected in series between nodes T1P and T1N, and a second pair of switches S₂ᵤ, S_{2d} connected in series between nodes T1P and T1N. The first pair of switches S₁ᵤ, S_{1d} and the second pair of switches S₂ᵤ, S_{2d} is connected in parallel. In the present embodiment, the switches S₁ᵤ, S_{1d}, S₂ᵤ, S_{2d} are MOSFET switches each with a respective body/bypass diode d₁ᵤ, d_{1d}, d₂, d_{2d} connected in an antiparallel manner. Node A defined between the first pair of switches S₁ᵤ, S_{1d}, and node B defined between the second pair of switches S₂ᵤ, S_{2d} are preferably connected with the resonance circuit 108 or the inductive component TR (in case where the circuit 100 lacks a resonance circuit 108). In the present embodiment, all of the switches S₁ᵤ, S_{1d}, S₂ᵤ, S_{2d} are operably connected with the controller 106 so as to be controlled by the controller 106.

FIG. 2B shows a first switching circuit 102B in accordance with another embodiment of the present invention. The first switching circuit 102B in this embodiment is a bridge circuit with the first pair of switches S₁ᵤ, S_{1d} connected in series between nodes T1P and T1N, and a pair of capacitors C₂ᵤ, C_{2d} connected in series between nodes T1P and T1N. The first pair of switches S₁ᵤ, S_{1d} and the pair of capacitors C₂ᵤ, C_{2d} is connected in parallel. The switches S₁ᵤ, S_{1d}, are preferably MOSFET switches each with a respective body/bypass diode d₁ᵤ, d_{1d} connected in an antiparallel manner. Node A defined between the first pair of switches S₁ᵤ, S_{1d}, and node B defined between the pair of capacitors C₂ᵤ, C_{2d} are preferably connected with the resonance circuit 108 or the inductive component TR (in case where the circuit 100 lacks a resonance circuit 108). In the present embodiment, all of the switches S₁ᵤ, S_{1d} are operably connected with the controller 106 so as to be controlled by the controller 106. Preferably, the capacitances of the capacitors C₂ᵤ, C_{2d} are large enough to maintain the voltages across them almost constant.

FIG. 2C shows yet another embodiment of the first switching circuit 102C. In this embodiment, the first switching circuit 102C is a half-bridge circuit with only the first pair of switches S₁ᵤ, S_{1d} connected in series between nodes T1P and T1N. The switches S₁ᵤ, S_{1d} are preferably MOSFET switches each with a respective body/bypass diode d₁ᵤ, d_{1d} connected in an antiparallel manner. Node A defined between the first pair of switches S₁ᵤ, S_{1d}, and node B defined to be the same as node T1N are preferably connected with the resonance circuit 108 or the inductive component TR (in case where the circuit 100 lacks a resonance circuit 108). In the present embodiment, all of the switches S₁ᵤ, S_{1d} are operably connected with the controller 106 so as to be controlled by the controller 106.

The switches S₁ᵤ, S_{1d}, S₂ᵤ, S_{2d} used in the embodiments of the switching circuit 102A-102C illustrated in FIGS. 2A-2C are all MOSFET switches. However, in other embodiments, the switches S₁ᵤ, S_{1d}, S₂ᵤ, S_{2d} may be any power semiconductor switches, transistors, or other switching components that can be controlled by one or more controllers. Examples of these transistors include bipolar junction transistors (BJT), junction gate field-effect transistors GFET), metal-oxide-semiconductor field-effect transistors (MOSFET), and hetero-structure field-effect transistors (HFET)/high-electron-mobility transistors (HEMT) that can be of any type (e.g., PNP, NPN) or channel (e.g., p-channel, n-channel), and can operate at different operation modes (e.g., depletion mode, enhancement mode). The switches in the first switching circuit are preferably of the same type. On the other hand, all the above embodiments of the first switching circuits 102A-102C include the first pair of switches S₁ᵤ, S_{1d}, that are essential in some embodiments of the present invention. The second pair of switches S₂ᵤ, S_{2d} is some embodiments, is optional, and may be omitted. In one embodiment, the first switching circuit 102 may include a second pair of switches S₂ᵤ, S_{2d} that are idle. In some other embodiments, the first switching circuit 102 may include other active or passive circuit components (e.g., diodes, capacitors, inductors, etc.) in addition to the first pair of switches S₁ᵤ, S_{1d}.

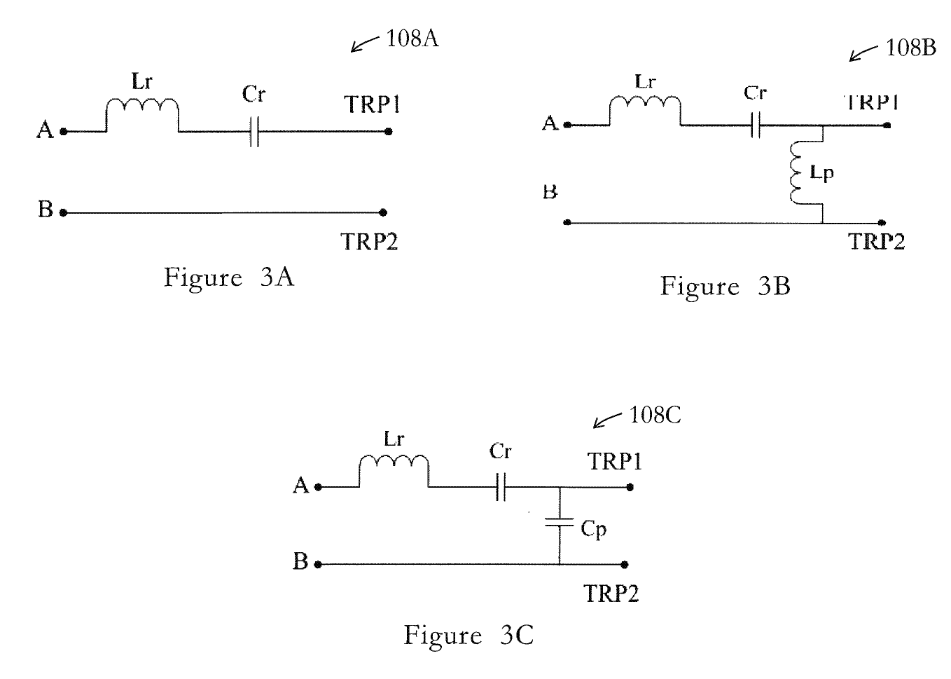

Referring back to FIG. 1, the converter circuit 100 also in some embodiments may include a resonance circuit 108 connected between the first switching circuit 102 (across nodes A and B) and the inductive component TR (across nodes TRP1 and TRP2). Different embodiments of the resonance circuit 108 are shown in FIGS. 3A to 3C, and can be used tougher with any embodiments of the first switching circuit 102, such that those illustrated in FIGS. 2A to 2C. In the embodiment of FIG. 3A, the resonance circuit 108A includes an inductor Lᵣ and capacitor Cᵣ pair connected in series between the first switching circuit 102 and the inductive component TR, between nodes A and TRP1. In the embodiment of FIG. 3B, the resonance circuit 108B includes the inductor Lᵣ and capacitor Cᵣ pair, and a further inductor Lₚ connected in parallel across an output of the first switching circuit, e.g., across nodes TRP1 and TRP2, downstream of the capacitor Cᵣ. In the embodiment of FIG. 3C, the resonance circuit 108C includes the inductor Lᵣ and capacitor Cᵣ pair, and a further capacitor Cₚ connected in parallel across an output of the first switching circuit 102, e.g., across nodes TRP1 and TRP2, downstream of the capacitor Cᵣ. In the present invention, the resonance frequency fᵣ of the inductor Lᵣ and capacitor Cᵣ pair is preferably substantially identical to a switching frequency (i.e., reciprocal of the switching period Tₚ) of the plurality of switches S₁ᵤ, S_{1d}, S₂ᵤ, S_{2d}, S_{3d}, S_{4d} in the first switching circuit 102 and the second switching circuit 104. In one example, the resonance frequency fᵣ is larger than but close to the switching frequency. The use of the further inductor Lₚ or the further capacitor Cₚ in some embodiments can improve the switching transient of the active switches S₁ᵤ, S_{1d}, S₂ᵤ, S_{2d}, S_{3d}, S_{4d}.The inductance of the further inductor Lₚ and the capacitance of the further capacitor Cₚ would not substantially affect the power being transferred from the voltage source V₁ to the load R_{L}.

In a preferred embodiment of the present invention, the inductive component TR is a transformer with a primary winding and a secondary winding. The transformer is arranged to provide galvanic isolation between the first switching circuit 102 and second switching circuit 104. The primary winding is preferably connected with the resonance circuit 108 through nodes TRP1 and TRP2, or with the first switching circuit 102 (in embodiments where the circuit 100 lacks a resonance circuit 108) through nodes A and B. The secondary winding is preferably connected with the second switching circuit 104 through nodes M and N. In the present embodiment, the transformer ratio of the transformer can be freely chosen to meet the requirements of different input-output voltage ratios. In another embodiment, the inductive component may be an inductor connected in series between the resonance circuit 108 (or the first switching circuit 102 in embodiments where the circuit 100 lacks a resonance circuit 108) and the second switching circuit 104.

The converter circuit 100 in the present invention further includes a second switching circuit 104 arranged to be connected across an input of the load R_{L}, between the inductive component TR and the load R_{L}. The second switching circuit 104 is preferably connected across the load R_{L} at nodes T2P and T2N. The second switching circuit 104 preferably includes a third pair of switches S_{3d}, S_{4d} connected in parallel with each other.

In one embodiment, each of the third pair of switches S_{3d}, S_{4d} is connected in series with a respective diode d₃, d₄ to form a switch-diode pair. Each of the switch-diode pair is arranged to be connected across the input of the load R_{L}, at nodes T2P and T2N. The switches S_{3d}, S_{4d} are preferably MOSFET switches each with a respective body/bypass diode d_{3d}, d_{4d} connected in an antiparallel manner. In other examples, the switches S_{3d}, S_{4d} may be any power semiconductor switches, transistors, or other switching components that can be controlled by one or more controllers 106. Examples of these transistors include bipolar junction transistors (BJT), junction gate field-effect transistors (JFET), metal-oxide-semiconductor field-effect transistors (MOSFET), and hetero-structure field-effect transistors (HFET)/high-electron-mobility transistors (HEMT) that can be of any type (e.g., PNP, NPN) or channel (e.g., p-channel, n-channel), and can operate at different operation modes (e.g., depletion mode, enhancement mode).. Node M defined between the switch S_{3d} and diode d₃ and node N defined between the switch S_{4d} and diode d₄ are preferably connected with each other through the inductive component TR, e.g., the secondary windings of the transformer. In the present embodiment, all of the switches S_{3d}, S_{4d} are operably connected with the controller 106 so as to be controlled by the controller 106. Optionally, an output capacitor Cₒᵤₜ that acts as a high frequency filter is connected across the load R_{L} at nodes T2P and T2N, between the second switching circuit 104 and the load R_{L}.

The converter circuit 100 in the present invention also includes a controller 106 operably connected with the switches S₁ᵤ, S_{1d}, S₂ᵤ, S_{2d} of the first switching circuit 102 and the switches S_{3d}, S_{4d} of the second switching circuit 104 to control their operation. In the present invention, the controller 106 may include one or more processors (e.g., MCU, CPU, or other integrated circuit chip with processor core, volatile and/or non-volatile memory, and programmable input/output peripherals). Preferably, the controller 106 also has input or detection means arranged to receive a control signal for controlling operation of the switches S₁ᵤ, S_{1d}, S₂ᵤ, S_{2d}, S_{3d}, S_{4d}. In other embodiments, the controller may be an information handling system (with one or more processors, memory modules, input/output devices, disk drives, communication modules, etc.), integrated or distributed, with one or more hardware and/or software components.

In a preferred embodiment of the present invention, the controller 106 is arranged to receive a control signal for controlling switching of the switches S₁ᵤ, S_{1d} (and S₂ᵤ, S_{2d} if present) of the first switching circuit 102 and the switches S_{3d}, S_{4d} of the second switching circuit 104. The controller 106 is also arranged to generate and provide gating signals to the plurality of the switches S₁ᵤ, S_{1d} (and S₂ᵤ, S_{2d} if present) of the first switching circuit 102 and the switches S_{3d}, S_{4d} of the second switching circuit 104 based on the control signal so as to regulate power transfer from the voltage source V₁ to the load R_{L}.

Preferably, the controller 106 is arranged to control the first pair of switches S₁ᵤ, S_{1d} and the third pair of switches S_{3d}, S_{4d} to have substantially identical switching period T. In the embodiment where the first switching circuit 102 includes and uses a second pair of switches S₂ᵤ, S_{2d}, the controller 106 may control the first pair of switches S₁ᵤ, S_{1d}, the second pair of switches S₂ᵤ, S_{2d}, and the third pair of switches S_{3d}, S_{4d} to have substantially identical switching period T. The controller 106 preferably controls all the switches S₁ᵤ, S_{1d}, S₂ᵤ, S_{2d}, S_{3d}, S_{4d} in the first switching circuit 102 and the second switching circuit 104 to have the same switching period Tₚ, even though the switches may or may not be switched-on at the same time. In the present embodiment, a switching period Tₚ may be defined from a switch-on time of switch S₁ᵤ to the next switch-on time of the same switch S₁ᵤ.

In the present embodiment, the controller 106 is arranged to switch on and off the first pair of switches S₁ᵤ, S_{1d} complementarily such that each of the first pair of switches has a duty cycle of about 50% with a dead time therebetween. In other words, the controller 106 is arranged to switch-on one of the first pair of switches and switch-off another one of the first pair of switches at substantially the same time. The controller 106 may further switch on and off the third pair of switches S_{3d}, S_{4d} complementarily such that each of the third pair of switches has a duty cycle of about 50% with a dead time therebetween. In other words, the controller 106 is arranged to switch-on one of the third pair of switches and switch-off another one of the third pair of switches at substantially the same time. In a preferred embodiment, the controller 106 is further arranged to control a duration T_{d} from a switch-on time of one of the first pair of switches S₁ᵤ to switch-on time of one of the third pair of switches S_{3d} based on the control signal. The duration T_{d} is preferably positive and is controlled to be between 0 and half the switching period T. Preferably, the duration T_{d} is the only variable parameter in the circuit 100 for controlling the amount of power flowing from the voltage source V₁ to the load R_{L}.

In embodiments where the converter circuit 100 includes and uses a second pair of switches S₂ᵤ, S_{2d}, the controller 106 may switch on and off the second pair of switches complementarily such that each of the second pair of switches has a duty cycle of about 50% with a dead time therebetween. In other words, the controller 106 is arranged to switch-on one of the second pair of switches and switch-off another one of the second pair of switch at substantially the same time. Preferably, the controller 106 also switches on and off one of the second pair of switches S_{2d} and one of the first pair of switches S₁ᵤ synchronously, and switches on and off another one of the second pair of switches S₂ᵤ and another one of the first pair of switches S_{1d} synchronously. That is, the controller 106 switches-on one of the second pair of switches and switches-on one of the first pair of switch at substantially the same time; and switches-off the one of the second pair of switches and switches-off the one of the first pair of switch at substantially the same time.

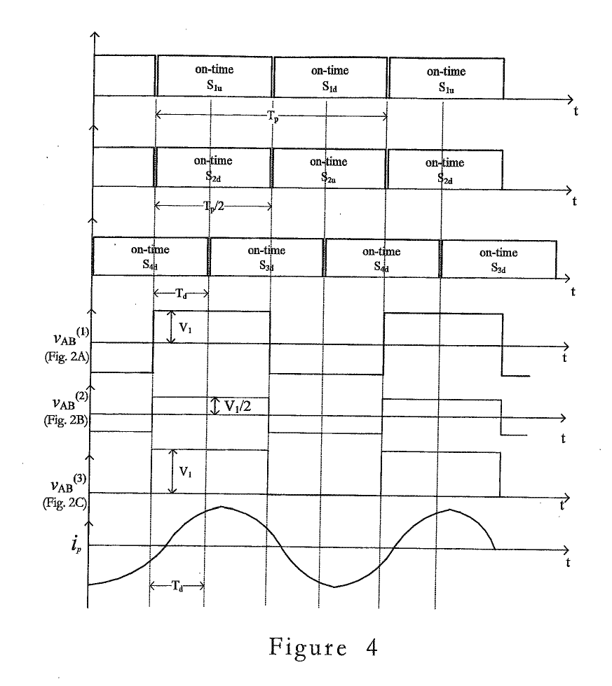

FIG. 4 shows the waveforms of the operation of the switches S₁ᵤ, S_{1d}, S₂ᵤ, S_{2d}, S_{3d}, S_{4d} in the converter circuit of FIG. 1, as well as the respective steady state voltage and current waveforms obtained from the converter circuit 100 of FIG. 1 incorporating the first switching circuit of FIGS. 2A to 2C. As shown in FIG. 4, all switches S₁ᵤ, S_{1d}, (and S₂ᵤ, S_{2d} if present), S_{3d}, S_{4d} have the same switching period Tₚ, defined as a duration between successive switch-on times of the first switch S1u. Also, each of the first pair of switches S₁ᵤ, S_{1d}, the second pair of switches S₂ᵤ, S_{2d} (if present), and the third pair of switches S_{3d}, S_{4d} are switched on and off complementarily. In embodiments where the first switching circuit 102 includes the second pair of switches S₁ᵤ, S_{2d}, one of the first pair of switches S₁ᵤ and one of the second pair of switches S_{2d} are switched on and off synchronously; and the other of the first pair of switches S_{1d} and the other of the second pair of switches S₂ᵤ are switched on and off synchronously. As shown in FIG. 4, the duration T_{d} between a switch-on time of the first switch s₁ᵤ and a switch-on time of the third switch s_{3d} is positive, between 0 and Tₚ/2.

FIG. 4 shows three voltage waveforms obtained across nodes A and B for converter circuits 100 with different embodiments of the first switching circuits 102A-102C. For the converter circuit 100 with the first switching circuit 102A of FIG. 2A, the voltage waveform is an AC square wave having a peak-to-peak amplitude 2V₁ (varies between +V₁ and −V₁). For the converter circuit 100 with the first switching circuit 102B of FIG. 2B, the voltage waveform is an AC square wave having a peak-to-peak amplitude V₁ (varies between +V₁/2 and −V₁/2). For the converter circuit 100 with the first switching circuit 102C of FIG. 2C, the voltage waveform is a DC square wave having a peak-to-peak amplitude V₁ (varies between +V₁ and 0). The waveform of the current iₚ in each of these embodiments is substantially sinusoidal.

Embodiments of the converter circuit and its operation method are particularly advantageous and adapted for applications with high voltage and low current, e.g., applications of switching-mode power supply, battery charger in a power range of several hundred watts to a few kilo-watts. Equipped with a high-frequency isolated transformer TR, embodiments of the converter circuit in the present invention can provide galvanic isolation between the input (e.g., power source) and the output (e.g. load), which increases safety and voltage-matching ability. Embodiments of the resonant circuits in the present invention can improve the switching transient. Also, in the present invention, all switches S₁ᵤ, S_{1d}, S₂ᵤ, S_{2d}, S_{3d}, S_{4d} can be turned on with zero voltage and can be turned off softly. All independent diodes d₃, d₄ can also be turned on and turned off with zero current. In embodiments of the present invention, the switching loss resulting from high-frequency switching behaviour in the converter circuit 100 is almost zero. All switches and diodes can work with nearly zero switching loss for a wide range of load. In addition, the power control methods in embodiments of the present invention are simple and can be readily adjusted. Other advantages of the present invention in terms of structure, function, cost, manufacture cost and ease, operation effectiveness, operation efficiency, etc., can be inferred by the person skilled in the art upon reading the description of the invention.

Although not required, the embodiments described with reference to the Figures can be implemented as an application programming interface (API) or as a series of libraries for use by a developer or can be included within another software application, such as a terminal or personal computer operating system or a portable computing device operating system. Generally, as program modules include routines, programs, objects, components and data files assisting in the performance of particular functions, the skilled person will understand that the functionality of the software application may be distributed across a number of routines, objects or components to achieve the same functionality desired herein.

It will also be appreciated that where the methods and systems of the present invention are either wholly implemented by computing system or partly implemented by computing systems then any appropriate computing system architecture may be utilised. This will include stand-alone computers, network computers and dedicated hardware devices. Where the terms “computing system” and “computing device” are used, these terms are intended to cover any appropriate arrangement of computer hardware capable of implementing the function described.

It will be appreciated by persons skilled in the art that numerous variations and/or modifications may be made to the invention as shown in the specific embodiments without departing from the spirit or scope of the invention as broadly described. The present embodiments are, therefore, to be considered in all respects as illustrative and not restrictive.

Any reference to prior art contained herein is not to be taken as an admission that the information is common general knowledge, unless otherwise indicated.

1. A converter circuit arranged to regulate power transfer from a power source to a load, comprising:
a first switching circuit arranged to be connected across an output of the power source, the first switching circuit comprises a plurality of switches;
a second switching circuit arranged to be connected across an input of the load, the second switching circuit comprises a plurality of switches;
an inductive component electrically connecting the first switching circuit with the second switching circuit; and
a controller operably connected with the plurality of switches in the first switching circuit and the plurality of switches in the second switching circuit, the controller being arranged to:
receive a control signal for controlling switching of the plurality of switches in the first switching circuit and the plurality of switches in the second switching circuit;
generate gating signals to be provided to the plurality of switches in the first switching circuit and the plurality of switches in the second switching circuit based on the control signal; and
provide the gating signals to the plurality of switches in the first switching circuit and the plurality of switches in the second switching circuit so as to regulate power transfer from the power source to the load.

2. A converter circuit in accordance with claim 1, wherein the plurality of switches of the first switching circuit comprises a first pair of switches connected in series such that the first pair of switches is arranged to be connected across the output of the power source.

3. A converter circuit in accordance with claim 2, wherein the first switching circuit further comprises a pair of capacitors connected in series, and the pair of capacitors is connected in parallel with the first pair of switches such that the pair of capacitors is arranged to be connected across the output of the power source.

4. A converter circuit in accordance with claim 2, wherein the plurality of switches of the second switching circuit comprises a third pair of switches connected in parallel such that each of the third pair of switches is arranged to be connected across the input of the load.

5. A converter circuit in accordance with claim 4, wherein each of the third pair of switches is connected with a respective diode in series to form a switch-diode pair, thereby forming two switch-diode pairs arranged to be connected in parallel across the input of the load.

6. A converter circuit in accordance with claim 1, wherein the inductive component is a transformer with a primary winding connected with the first switching circuit and a secondary winding connected with the second switching circuit.

7. A converter circuit in accordance with claim 6, further comprising:
a resonance circuit connected between the first switching circuit and the inductive component.

8. A converter circuit in accordance with claim 7, wherein the resonance circuit comprises:
an inductor and capacitor pair connected in series between the first switching circuit and the inductive component.

9. A converter circuit in accordance with claim 8, wherein a resonance frequency of the inductor and capacitor pair is substantially identical to a switching frequency of one or more of the plurality of switches in the first switching circuit and the plurality of switches in the second switching circuit.

10. A converter circuit in accordance with claim 8, wherein the resonance circuit further comprises:
a further inductor or a further capacitor connected in parallel across an output of the first switching circuit.

11. A converter circuit in accordance with claim 4, wherein the controller is arranged to control the first pair of switches and the third pair of switches to have substantially identical switching period.

12. A converter circuit in accordance with claim 11, wherein the controller is further arranged to perform one or more of the following:
switch on and off the first pair of switches complementarily such that each of the first pair of switches has a duty cycle of about 50% with a dead time therebetween;
switch on and off the third pair of switches complementarily such that each of the third pair of switches has a duty cycle of about 50% with a dead time therebetween; and
control a duration from a switch-on time of one of the first pair of switches to switch-on time of one of the third pair of switches based on the control signal, wherein the duration is controlled to be between 0 and half the switching period.

13. A converter circuit in accordance with claim 12, wherein the plurality of switches of the first switching circuit further comprises a second pair of switches connected in series, the second pair of switches is connected in parallel with the first pair of switches; and the controller is further arranged to control the first pair of switches, the second pair of switches and the third pair of switches to have substantially identical switching period.

14. A converter circuit in accordance with claim 13, wherein the controller is further arranged to:
switch on and off the second pair of switches complementarily such that each of the second pair of switches has a duty cycle of about 50% with a dead time therebetween;
switch on and off one of the second pair of switches and one of the first pair of switches synchronously; and
switch on and off another one of the second pair of switches and another one of the first pair of switches synchronously.

15. A converter circuit in accordance with claim 1, further comprising:
an input capacitor arranged to be connected across the power source, between the power source and the first switching circuit; and
an output capacitor arranged to be connected across the second switching circuit, between the second switching circuit and the load.

16. A converter circuit in accordance with claim 1, wherein the plurality of switches in the first switching circuit and the plurality of switches in the second switching circuit are controllable power semiconductor switches.

17. A method for operating a converter circuit arranged to regulate power transfer from a power source to a load, comprising the steps of:
receiving a control signal for controlling switching of a plurality of switches in a first switching circuit and a plurality of switches in a second switching circuit of the converter circuit, wherein the first switching circuit is arranged to be connected across an output of the power source, the second switching circuit is arranged to be connected across an input of the load, and the first and second switching circuits are electrically connected through an inductive component;
generating gating signals to be provided to the plurality of switches in the first switching circuit and the plurality of switches in the second switching circuit based on the control signal; and
providing the gating signals to the plurality of switches in the first switching circuit and the plurality of switches in the second switching circuit so as to regulate power transfer from the power source to the load.

18. A method in accordance with claim 17, wherein the plurality of switches of the first switching circuit comprises a first pair of switches connected in series such that the first pair of switches is arranged to be connected across the output of the power source; and the plurality of switches of the second switching circuit comprises a third pair of switches connected in parallel such that each of the third pair of switches is arranged to be connected across the input of the load; and
the method further comprises one or more of the following steps:
controlling the first pair of switches and the third pair of switches to have substantially identical switching period;
switching on and off the first pair of switches complementarily such that each of the first pair of switches has a duty cycle of about 50% with a dead time therebetween;
switching on and off the third pair of switches complementarily such that each of the third pair of switches has a duty cycle of about 50% with a dead time therebetween; and
controlling a duration from a switch-on time of one of the first pair of switches to switch-on time of one of the third pair of switches based on the control signal, wherein the duration is controlled to be between 0 and half the switching period.

19. A method in accordance with claim 18, wherein the plurality of switches of the first switching circuit further comprises a second pair of switches connected in series, the second pair of switches is connected in parallel with the first pair of switches; and
the method further comprises one or more of the following steps:
controlling the first pair of switches, the second pair of switches and the third pair of switches to have substantially identical switching period;
switching on and off the second pair of switches complementarily such that each of the second pair of switches has a duty cycle of about 50% with a dead time therebetween;
switching on and off one of the second pair of switches and one of the first pair of switches synchronously; and
switching on and off another one of the second pair of switches and another one of the first pair of switches synchronously.

20. A controller for a converter circuit arranged to regulate power transfer from a power source to a load, wherein the controller is arranged to:
receive a control signal for controlling switching of a plurality of switches in a first switching circuit and a plurality of switches in a second switching circuit of the converter circuit, wherein the first switching circuit is arranged to be connected across an output of the power source, the second switching circuit is arranged to be connected across an input of the load, and the first and second switching circuits are electrically connected through an inductive component;
generate gating signals to be provided to the plurality of switches in the first switching circuit and the plurality of switches in the second switching circuit based on the control signal; and
provide the gating signals to the plurality of switches in the first switching circuit and the plurality of switches in the second switching circuit so as to regulate power transfer from the power source to the load.
